(19) United States
(12) Patent Application Publication
(10) Pub. No.: US 2008/0047769 A1
(43) Pub. Date: Feb. 28, 2008

(54) Engine transmission carrier

(76) Inventor: Joerg Haehnel, Winnenden-BirKmannsweiler (DE)

Correspondence Address: KLAUS J. BACH, 4407 TWIN OAKS DRIVE, MURRYSVILLE, PA, 15668, US

(21) Appl. No.: 11/899,392

(22) Filed: Sep. 5, 2007

Related U.S. Application Data
(63) Continuation-in-part of application No. PCT/EP06/01821, filed on Feb. 28, 2006.

(30) Foreign Application Priority Data
Mar. 5, 2005 (DE) 10 2005 010 2336

(51) Int. Cl. B60K 5/12; F16F 7/12

(52) U.S. Cl. 180/232

(57) ABSTRACT

In an engine transmission carrier for a rear drive motor vehicle having a longitudinally installed front engine transmission unit, wherein, in order to obtain an optimum between the noise level in the vehicle interior space, the weight and the accident safety of the vehicle, the engine transmission carrier is composed of a sheet metal lower part and a light metal upper part which is attached to the lower part and is relatively stiff, the engine transmission carrier is dimensioned such that, in the event of an accident, the light metal upper part breaks, whereas the sheet metal lower part is plastically deformed for guiding the transmission safety while absorbing the crush impact.

This is a Continuation-In-Part Application of pending International Patent Application PCT/EP2006/001821 filed Feb. 28, 2006 and claiming the priority of German Patent Application 10 2005 010 233.6 filed Mar. 5, 2005.

### BACKGROUND OF THE INVENTION

The invention relates to an engine transmission carrier for a motor vehicle having a longitudinally installed engine transmission unit with a drive shaft extending to the rear and the transmission disposed in a tunnel.

DE 198 21 107 A1 discloses an engine transmission carrier of this type which is used in a motor vehicle having a longitudinally mounted front engine-transmission unit whose transmission is arranged within a tunnel and from which a driveshaft extends to a rear-wheel drive axle.

In addition, DE 28 47 679 A1 shows a tunnel for a vehicle having a longitudinally installed front engine transmission unit whose transmission is arranged within a tunnel and a driveshaft extends to a rear-wheel drive axle.

It is the principle object of the present invention to provide an engine-transmission carrier with a high level of accident safety features and a high level of engine noise decoupling from the vehicle interior space.

### SUMMARY OF THE INVENTION

In an engine transmission carrier for a rear drive motor vehicle having a longitudinally installed front engine transmission unit, wherein, in order to obtain an optimum between the noise level in the vehicle interior space, the weight and the accident safety of the vehicle, the engine transmission carrier is composed of a sheet metal lower part and a light metal upper part which is attached to the lower part and is relatively stiff, the engine transmission carrier is dimensioned such that, in the event of an accident, the light metal upper part breaks, whereas the sheet metal lower part is plastically deformed for guiding the transmission safety while absorbing the crush impact.

The stiff light metal upper part considerably stiffens out the tunnel, so as to result in a low susceptibility to air noise and therefore provides for a low noise level in the passenger compartment. As a result of the stiff yet weight-optimized design, the light metal upper part can easily break in the event of an accident. Then advantageously, the transmission can be pushed rearward in the tunnel in the event of a direct or offset frontal impact, with a deforming—but non-breaking—sheet metal lower part preventing that the transmission is pushed downward and absorbing the impact forces.

The light metal upper part can in a particularly advantageous way be composed of aluminum or an aluminum alloy. The light metal part can however also be composed of magnesium or a magnesium alloy. The light metal upper part can be embodied in particular as a hollow-cast pressure-die-cast part. Likewise possible is the use of a light metal foam in the manufacture of the upper part.

In a particularly advantageous way, the light metal upper part can be connected, coupled by means of a decoupling element, directly to the transmission or alternatively supported by means of a transmission holder. The decoupling element may comprise an elastomer body.

The elastomer body can be arranged in particular between a mount core and a mount housing. Here, the mount housing can be directly or indirectly fixedly screwed to the transmission housing, whereas the mount housing is fixedly screwed, or press-fitted, to the light metal upper part.

In a particularly advantageous way, the mount core can be connected—in particular screwed—fixedly in terms of movement to a transmission holder which is screwed to the transmission. As a result of the separate mount core and the transmission holder, a plurality of advantages is obtained:

The mount core can be of relatively small design, so that the latter can be easily vulcanized with the elastomer body. Large mount cores could only be inserted with difficulty into a machine tool for vulcanization. In addition, the same transmission holder can be used for different series of vehicles and/or different transmissions. The different installation lengths resulting from the different series of vehicles and/or the different transmissions can be compensated by varying the mount core. Likewise, the transmission holder can be varied according to the transmission. In this way, even the same unit composed of a sheet metal lower part, a light metal upper part and a mount core can be used for different transmissions whose transmission housing connecting flange deviate from one another. By dispensing with a transmission holder, it is even possible to screw particularly large transmissions directly to the mount core, while, in the case of smaller transmissions, a separate transmission holder is used. A large transmission is for example an all-wheel-drive version with an additional longitudinal transfer case and a side drive output, which is therefore elongated with respect to a standard variant. The standard variant is the simple rear-wheel drive without an additional front-wheel drive. With regard to the design of an all-wheel-drive drive train of said type or a standard drive, reference is made to EP 1321327 A2 which, in this regard, is to be considered as also being included in this application.

It is possible in a particularly advantageous way for acoustic decoupling or vibration damping to be provided between the light metal upper part and the sheet metal lower part. Here, the light metal upper part and the sheet metal lower part act as a dual-mass system. It is for example possible for this purpose for one or more elastomer bodies to be provided between the light metal upper part and the sheet metal lower part. Said elastomer bodies can be attuned in a targeted fashion, by means of their stiffness, their preload, their damping property, their number and their position, to vibration phenomena which are perceived to be objectionable, in order for example to reduce transmission whine or drone.

The invention will become more readily apparent from the following description thereof on the basis of the accompanying drawings.

### BRIEF DESCRIPTION OF THE DRAWINGS

FIG. 1 shows, in a perspective view, an engine transmission carrier, with an additional section being plotted in order to illustrate profiles,

FIG. 2 shows the engine transmission carrier of FIG. 1 in a side view, with an additional section being plotted,

FIG. 3 shows the engine transmission carrier in a plan view,

FIG. 4 shows the engine transmission carrier in a view from the rear and

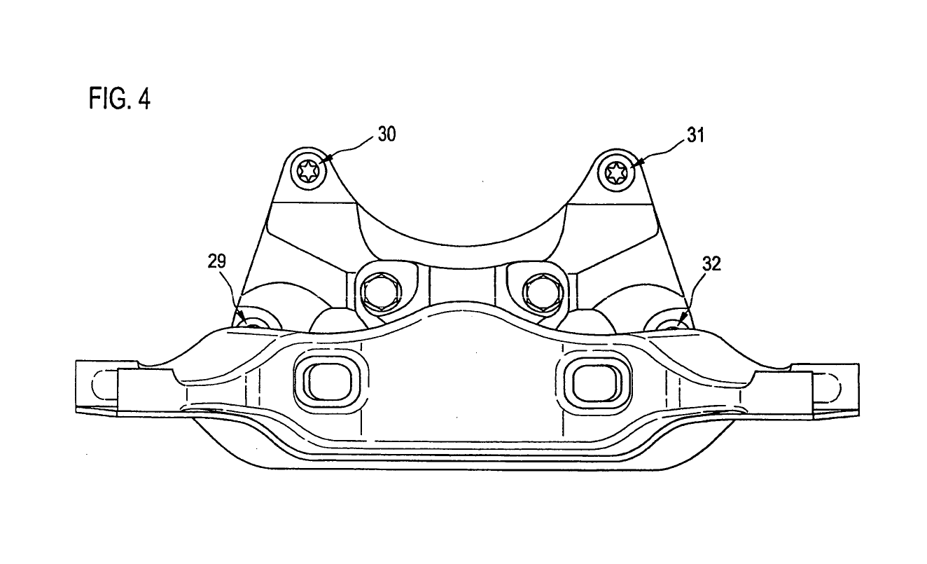

FIG. 5 shows, in an alternative embodiment, a light metal upper part of an engine transmission carrier with three elastomer bodies for acoustic decoupling or for vibration damping.

### DESCRIPTION OF TWO EXEMPLARY EMBODIMENTS

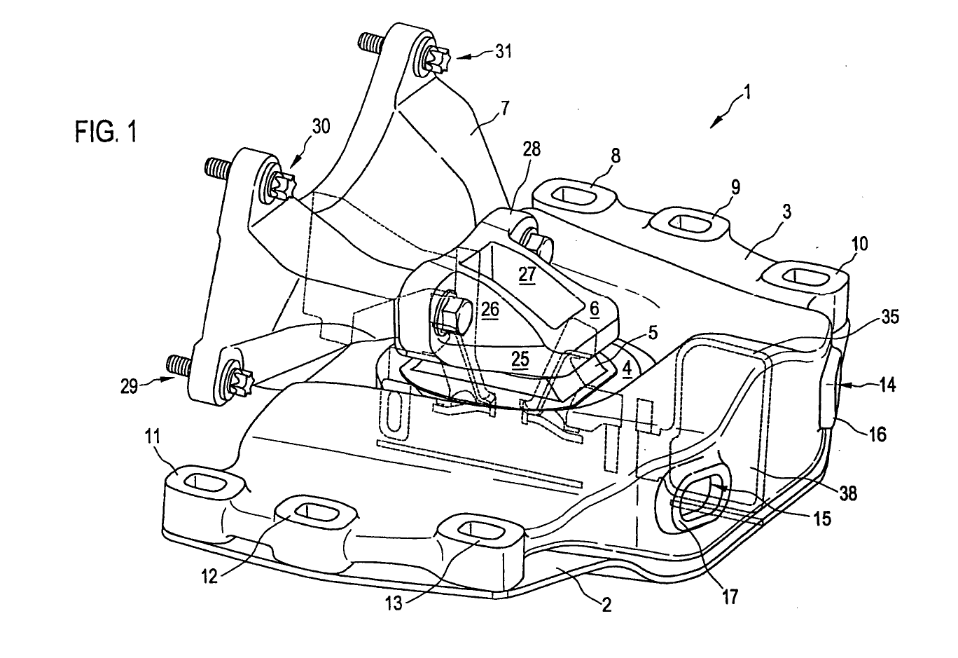

FIG. 1 shows, in a perspective view, an engine transmission carrier 1 for a motor vehicle. Included in the perspective view is a section along the central vehicle longitudinal-vertical plane. The motor vehicle has a longitudinally installed front engine transmission unit (not illustrated) which comprises a drive motor and a transmission. The transmission is arranged within a tunnel and transmits power via a drive input shaft to a rear-wheel drive. The installation type of an engine transmission unit in a tunnel is well-known from high-torque vehicles of the Assignee, for which reason this installation type is not discussed in any more detail. In addition, this installation type is illustrated in DE 198 21 107 A1, DE 28 47 679 A1 and EP 1273473 A2.
The engine transmission carrier 1 comprises
   a sheet metal lower part 2,
   a light metal upper part 3 which is arranged above the sheet metal lower part 2,
   a mount housing 4 which is screwed to the light metal upper part 3,
   an elastomer ring 5 which is vulcanized onto the mount housing 4,
   a mount core 6 which is vulcanized onto the elastomer ring 5, and
   a transmission holder 7 which is screwed fixedly in terms of movement to the mount core 6.

The light metal upper part 3 has, on the right and left sides in the vehicle longitudinal direction; in each case three mount eyes 8, 9, 10, 11, 12, 13 whose recesses are aligned with a total of six punched-out portions in the sheet metal lower part 2. Screws are inserted through said punched-out portions and recesses and are screwed to reinforced threaded blind holes on the vehicle body in the edge region of the tunnel. In this way, the sheet metal lower part 2 and the light metal upper part 3 close off the tunnel in a lower partial region. The stiffness of the body in the region of the tunnel, in which vibrations from the engine transmission unit are introduced, is very considerably increased. This results in a low susceptibility to air noise and therefore a low noise level in the vehicle interior space.

The sheet metal lower part 2 is produced as a deep-drawn part from steel, which deep-drawn part—as explained further below—is optimized with regard to the deformation in the event of an accident. In contrast, the light metal upper part 3 is produced as a pressure-die-cast part which is hollow-cast in a sand-casting process, so that the light metal upper part 3 is relatively stiff and reduces vibrations and the transmission of noises to the best possible degree. For this purpose, a hollow body 38 of the light metal upper part 3 has a U-shaped basic shape which is open to the front in the direction of travel. The U-shaped hollow body 38 has in each case two manufacturing-related openings 14, 15 at the rear end in the direction of travel, which openings 14, 15 are designed to be stiffened in each case at an edge 16, 17.

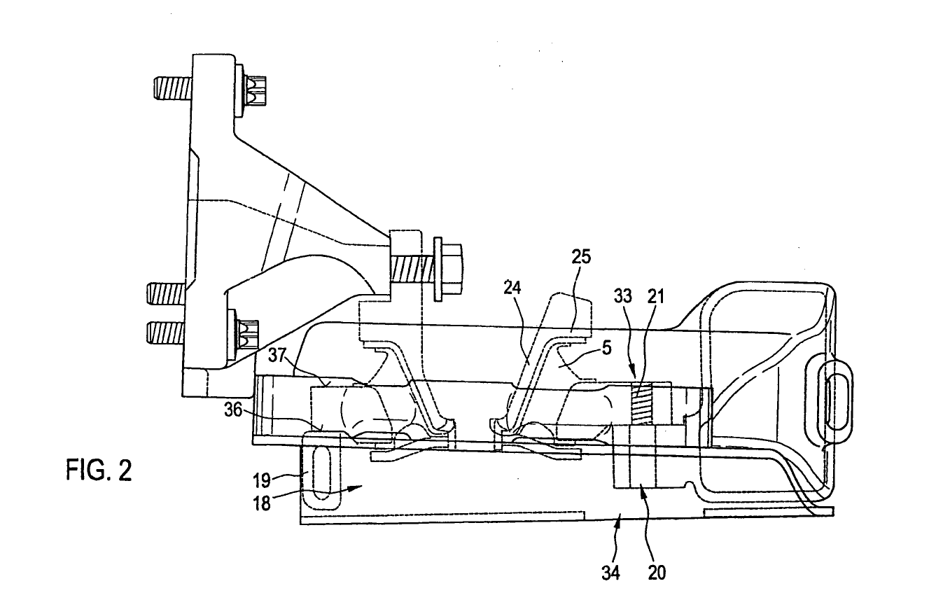

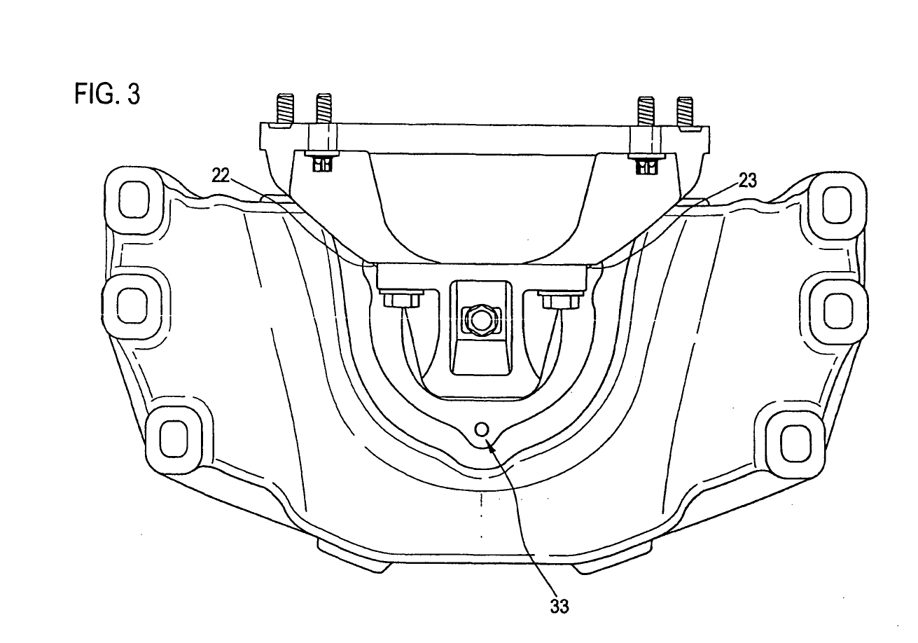

Within the U-shaped hollow body 38, the light metal upper part 3 is flattened and provided with a recess 18 which can be seen in FIG. 2. The edge of said recess is embodied, for the purpose weight reduction, as a hollow body 19 at the front end in the direction of travel and as a solid body at the rear end. Said hollow body 19 is of a profile considerably smaller than the U-shaped hollow body whose U-shaped base body is closed off at the front end by the hollow body 19. A bore 20 extends vertically through the solid body, which bore 20 is aligned with a threaded bore 21 in the mount housing 4. A screw (not illustrated) is inserted through the bore 20 from below and is screwed into the threaded bore 21. Formed similarly to the screw connection 33, two further screw connections 22, 23 are provided uniformly distributed on the periphery of the mount housing, which can be seen in FIG. 3. At the screw connections 22, 23, the light metal upper part 3 is embodied as a solid structure.

By means of this complex shaping which is divided into a solid body and hollow body, an optimum between weight, stiffness and strength is obtained in the light metal upper part 3 in the region of the screw connections.

The mount housing 4 has a ring-like basic shape, into which the elastomer ring 5 is vulcanized. The surface of the elastomer ring 5 is inclined obliquely upward and radially inward. The high weight of the rear transmission part can be accommodated by means of said shaping. This weight is introduced by the mount core 6 which, in the connecting region to the elastomer ring 5, is of conical shape corresponding to the shape described above. The cone shape 24 projects radially outward above the elastomer ring 5 to form a collar 25. This collar 25 is adjoined by stiffening ribs 26, 27 which are inclined obliquely forward and upward and absorb forces introduced by the engine transmission unit, so that a connecting flange 28 is protected from breaking. At the right and left sides of the two stiffening ribs 26, 27, bores are formed in the connecting flange 28, through which bores screws are inserted and screwed into the transmission holder 7. From said connecting point to the connecting flange 28, the transmission holder widens in the shape of a pyramid to a connecting face to the transmission which is attached by means of four screw connections 29, 30, 31, 32 to the transmission holder 7.

The sheet metal lower part 2 is deep-drawn from a relatively soft steel and, in terms of its main features, follows the contour on the lower side of the light metal upper part 3. As can be seen in FIG. 2, the sheet metal lower part 2 however runs in the lowest plane of the sheet metal lower part 2 in the region of the recess 18. This ensures that the mount core 3 has sufficient movement play in the downward direction. The sheet metal lower part 2 has, under the three screw connections 33, 22, 23, three punched-out portions, one punched-out portion 34 of which can be seen in FIG. 2. Said punched-out portions ensure accessibility to the three screw connections 33, 22, 23 from below.

The light metal upper part 3, which is stiff relative to the sheet metal lower part 2, breaks in the event of an average frontal impact, so that the light metal upper part 3 itself releases the transmission. The engine transmission carrier is however dimensioned such that, in the event of an average frontal impact or offset frontal impact, the sheet metal lower part plastically deforms but does not break. This ensures that the transmission of the engine transmission unit cannot move freely downward but rather is guided rearward. This increases the safety in the passenger compartment on account of the guided movement path.

In order to obtain an optimum with regard to installation space utilization, stiffness and weight, the light metal upper part 3 has the said basic shape with the U-shaped hollow body 38. The rear end of the hollow body 38 in the direction of travel forms the highest point 35 of the light metal upper part 3. Said U-shape is closed off at the front end by means of the hollow body 19. The upper edge 36 of said hollow body 19 is situated so far below said highest point 35 that the upper edge 36 belongs to a plane on which the mount housing 4 lies, so that an upper edge 37 of the mount housing 4 is situated below a three-dimensionally shaped structure of the upper edge of the U-shaped hollow body 38.

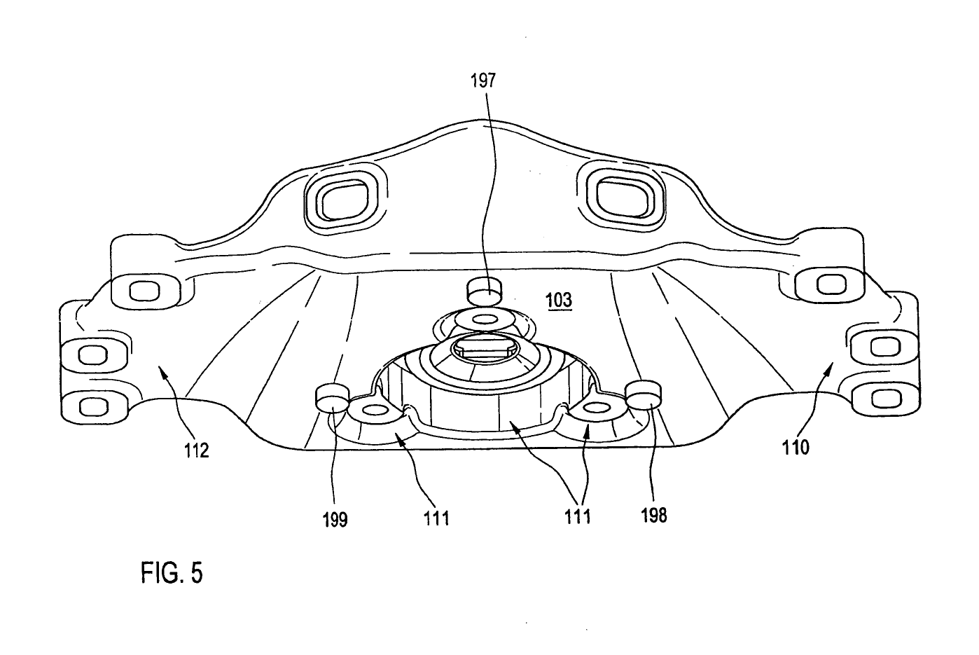

FIG. 5 shows, in an alternative embodiment, a light metal upper part 103 of an engine transmission carrier with three elastomer bodies 197, 198, 199 for acoustic decoupling or for vibration damping. Here, the light metal upper part 103 is illustrated in a view from the rear/from below. The three elastomer bodies 197, 198, 199 are distributed uniformly on the underside of the light metal upper part 103. In the installed state of the engine transmission carrier, the elastomer bodies 197, 198, 199 are clamped between the light metal upper part 103 and the sheet metal lower part which is not shown in FIG. 5. Here, the number of three elastomer bodies ensures secure clamping of all three elastomer bodies 197, 198, 199. The three elastomer bodies 197, 198, 199 are arranged in a central region 111 between the screw connections 112 which are situated at the left in the vehicle longitudinal direction and the screw connections 110 which are arranged at the right in the vehicle longitudinal direction. This ensures a relatively great spacing of the elastomer bodies 197, 198, 199 to the screw connections 110, 112, as a result of which the elastomer bodies 197, 198, 199 can dampen the sheet metal lower part in the region of the maximum vibration amplitude, and are not clamped too tightly at the screw connections 110 and 112.

Depending on the arrangement, however, any desired other number of elastomer bodies is possible.

The elastomer bodies can be fixed both at one side with respect to the light metal upper part or else alternatively with respect to the sheet metal lower part. Likewise, the elastomer bodies can be fixed at both sides. Assembly is facilitated both by means of the single-sided fixing and also by means of the fixing at both sides. For fixing, the elastomer bodies can for example be of pin-shaped design at their ends and can be inserted in bores of the light metal upper part 103.

The described embodiments are merely exemplary embodiments. A combination of the described features for different embodiments is likewise possible. Further features, which have not specifically been described, of the device parts which belong to the invention can be gathered from the geometries of the device parts which are illustrated in the drawings.

1. An engine transmission carrier (1) for a motor vehicle having a longitudinally installed front engine transmission unit with the transmission being arranged within a tunnel and a driveshaft extending from the transmission to a rear-wheel drive unit, said engine transmission carrier (1) being composed of a sheet metal lower part (2) and a light metal upper part (3) which is stiff relative to the sheet metal lower part (2), said engine transmission carrier (1) being dimensioned such that, in the event of an accident, the light metal upper part (3) breaks, whereas the sheet metal lower part (2) is plastically deformed but will not break and will support the transmission as it is pushed backward in the tunnel.

2. The engine transmission carrier as claimed in claim 1, wherein the light metal upper part (3) is a light metal pressure-die-cast part, whereas the sheet metal lower part (2) is composed of rolled or deep-drawn sheet steel.

3. The engine transmission carrier as claimed in claim 1, wherein recesses are formed in the light metal upper part (3) on opposite sides of the longitudinal center axis, said recesses being aligned with recesses in the sheet metal lower part (2), and screws extend through the recesses and being screwed into the body in the region of the tunnel, so that a shape which is closed off by the engine transmission carrier (1) is formed within the tunnel, within which part of the transmission is accommodated, so that the transmission is movable rearward in the event of a frontal impact.

4. The engine transmission carrier as claimed in claim 1, wherein the engine transmission carrier (1) comprises a mount housing (4) which is screwed to the light metal upper part (3), an elastomer body (5) which is connected to said mount housing (4), and a mount core (6) which is connected to said elastomer body (5).

5. The engine transmission carrier as claimed in claim 4, wherein the mount core (6) is bolted to the transmission with the interposition of a separate transmission holder (7).

6. The engine transmission carrier as claimed in claim 4, wherein the mount housing (4) and the light metal upper part (3) are connected to one another from below by screws with recesses (34) being arranged in the sheet metal lower part (2) in the region of said screws, which recesses (34) permit access to the screws.

7. The engine transmission carrier as claimed in claim 4, wherein the surface of the elastomer body (5) is inclined so as to extend obliquely upward and radially inward and supports a part of the weight of the engine transmission unit.

8. The engine transmission carrier as claimed in 4, wherein the sheet metal (2) is closed below the mount core (6) and, in the center thereof, has a greater spacing from the lower edge of the mount core (6) than at the edge regions of the sheet metal (2).

9. The engine transmission carrier as claimed in claim 4, wherein the mount core (6) narrows conically in the downward-pointing direction.

10. The engine transmission carrier as claimed in claim 4, wherein the light metal upper part (3) is basically in the form of a U-shaped hollow body (38) whose rear end in the direction of travel, forms the highest point (35) of the light metal upper part (3), with said U-shape being closed off at the forward end by means of a hollow body (19) whose upper edge (36) is situated so far below said highest point (35) that the upper edge (36) belongs to a plane on which the mount housing (4) lies, so that an upper edge (37) of the mount housing (4) is situated below a three-dimensionally shaped structure of the upper edge of the U-shaped hollow body (38).

11. The engine transmission carrier as claimed in claim 1, wherein elastomer bodies (197, 198, 199) are clamped between the light metal upper part (103) and the sheet metal lower part.

12. The engine transmission carrier as claimed in claim 11, wherein the elastomer bodies (197, 198, 199) are arranged in a central region (111) between screw connections (110, 112) which clamp the light metal upper part (103) between the sheet metal lower part and the vehicle body.
